(19) United States
(12) Patent Application Publication
(10) Pub. No.: US 2019/0394292 A1
(43) Pub. Date: Dec. 26, 2019

(54) Method for Transferring Operating Data of an Automation System to a Cloud Memory, and Gateway

(71) Applicant: Lenze Automation GmbH, Aerzen (DE)

(72) Inventors: Jens BORIES, Bielefeld (DE); Tobias SCHILGEN, Horn-Bad Meinberg (DE)

(21) Appl. No.: 16/448,032

(22) Filed: Jun. 21, 2019

(30) Foreign Application Priority Data
Jun. 22, 2018 (DE) 10 2018 210 201.5

(51) Int. Cl. H04L 29/08; G06F 16/25

(52) U.S. Cl. CPC H04L 67/2823; G06F 16/258; H04L 67/2871; H04L 67/2809; H04L 67/1097

(57) ABSTRACT

A method transfers operating data of an automation system to a cloud memory, wherein the cloud memory is selectable from a set of different types of cloud memories. The method has the steps of: transferring the operating data from the automation system to a gateway; using the gateway to read in a configuration file, wherein the configuration file has a type-determining entry determining the type of cloud memory into which the operating data are to be loaded; using the gateway to format the operating data on the basis of the type-determining entry of the configuration file; and using the gateway to load the formatted operating data into the cloud memory.

### CROSS REFERENCE TO RELATED APPLICATIONS

This application claims priority under 35 U.S.C. § 119 from German Patent Application No. 10 2018 210 201.5, filed Jun. 22, 2018, the entire disclosure of which is herein expressly incorporated by reference.

### BACKGROUND AND SUMMARY OF THE INVENTION

The invention relates to a method for transferring operating data of an automation system to a cloud memory, and to a gateway.

The invention is based on the object of providing a method for transferring operating data of an automation system to a cloud memory and a gateway that are configurable in as flexible a manner as possible.

The invention achieves this object by way of a method, as well as a gateway for executing the method, for transferring operating data of an automation system to a cloud memory, wherein the cloud memory is selectable from a set of different types of cloud memories, wherein the method comprises the steps of: transferring the operating data from the automation system to a gateway; using the gateway to read in a configuration file, wherein the configuration file has a type-determining entry determining the type of cloud memory into which the operating data are to be loaded; using the gateway to format the operating data on the basis of the type-determining entry of the configuration file; and using the gateway to load the formatted operating data into the cloud memory.

The method according to the invention is used for transferring operating data of an automation system to a cloud memory. The automation system can in particular be an electrical drive system or have an electrical drive system.

The operating data can for example be adjustable or set parameters of components of the automation system. The operating data can for example further be data that arise during operation of the automation system, for example delays, quantities, temperatures, torques, error messages, etc.

The cloud memory is selectable from a set of different types of cloud memories. The cloud memories have the necessary IT infrastructure, such as for example memory space, computing power and/or application software, provided as a service via a network, without the necessary memory needing to be present in the automation system itself. For the fundamental properties of cloud memories, reference may otherwise also be made to the relevant specialist literature.

The operating data to be stored or to be processed are transferred from the automation system or the components of the automation system to a gateway via a suitable network. This can be accomplished using conventional data transfer protocols, for example.

The gateway is used to read a configuration file. The configuration file may be stored in the gateway or may be stored on a network memory to which the gateway has access, for example. The configuration file contains a type-determining entry indicating the type of cloud memory into which the operating data are to be loaded. The configuration file can have an XML format, for example.

The gateway is used to format the operating data according to the type-determining entry of the configuration file.

The gateway is finally used to load the formatted operating data into the cloud memory.

According to one embodiment, the different types of cloud memories are selected from an exemplary set comprising: Microsoft Azure, Amazon AWS, SAC

Cumulocity, SAP Cloud Platform.

According to one embodiment, the gateway loads the formatted operating data into the cloud memory by means of the Message Queue Telemetry Transport (MQTT) protocol.

According to one embodiment, the automation system has a number (for example between 1 and 100) of frequency converters connected to the gateway by a field bus for the purpose of data interchange, wherein operating data of the frequency converters, which form the total of the operating data, are transferred to the gateway by the field bus. It goes without saying that the automation system can also have other devices or components, for example IPC controllers and/or sensors, the operating data of which, according to the invention, are loaded into the cloud memory.

According to one embodiment, a respective type of a cloud memory selected from a set of different types of cloud memories is assigned a type-specific formatting module, wherein the type-specific formatting module is selected from a set of type-specific formatting modules. The gateway is designed to take the type-determining entry of the configuration file as a basis for selecting the associated type-specific formatting module from the set of type-specific formatting modules and then to use the selected formatting module to format the operating data in type-specific fashion.

According to one embodiment, the gateway is designed to format the operating data by means of a type-aspecific standard formatting module if the type-determining entry of the configuration file has no assigned type-specific formatting module in the set of type-specific formatting modules.

The gateway according to the invention is configured to perform the method described above.

The provision of operating data from components of an automation system for storage and further analysis on cloud platforms or cloud memories and applications running thereon is a current object and one that will increasingly arise in the future.

According to the invention, the gateway collects (operating) data from different devices of the automation system. The devices are to this end typically connected to the gateway via a field bus. The data collected in this manner are conditioned or formatted by the gateway in accordance with a configuration and for example transferred to an MQTT broker by way of the MQTT protocol. The MQTT broker is the interface to the cloud or to the cloud memory.

The gateway according to the invention is capable of interacting with any cloud providers. To this end, the data content or operating data, for example device parameter values, is/are conditioned for the cloud system used as appropriate.

Since the data-agnostic protocol MQTT defines only how the data are transmitted, but does not define how the data are structured, there are usually differences between different cloud providers in terms of the structure of the data to be transferred.

According to the invention, the cloud-specific formatting or data conditioning is separated from the actual gateway functionality and split into an implementation part, that is to say conversion code, and into a configuration describing which data are to be converted and which conversion module is supposed to be used therefor.

The gateway implementation first of all loads all the formatting modules or conversion software modules for example from a directory intended therefor. The different formatting modules are for example identified by a name declared in each formatting module as a property (for example “Cumulocity” for a converter for the Cumulocity cloud, etc.). This name can easily be read by the gateway. The implementations of a conversion are thus for example managed in a table and are selectable by their names.

In a second step, the gateway loads a type-determining entry or a conversion configuration from a configuration file. The latter describes which formatting module or conversion module is supposed to be used to condition or format the operating data. To this end, for example the same name as was declared in the applicable type-determining entry is entered into the conversion configuration.

In a third step, a check is performed to determine whether the type-determining entry or the name of the formatting module that is in the configuration file is known. If so, this formatting module is used to format the captured operating data. Otherwise, a type-aspecific standard formatting module is used that converts or formats the operating data into a standard format (e.g. JSON). This ensures that it is always possible for data to be published.

In a last step, the operating data thus conditioned are published, i.e. for example transferred to the cloud by means of MQTT.

The invention permits simple formatting and control of the data transmission to the cloud platform. The gateway functionality is easily able to have the implementation of the data matching added to it, and the data matching is easily configurable. The gateway functionality can therefore easily be matched to user requirements.

Other objects, advantages and novel features of the present invention will become apparent from the following detailed description of one or more preferred embodiments when considered in conjunction with the accompanying drawings.

### BRIEF DESCRIPTION OF THE DRAWINGS

FIG. 1 schematically shows an automation system and an associated gateway that communicates with a cloud memory,

FIG. 2 is a block diagram of functional components of the gateway shown in FIG. 1, and

FIG. 3 is a schematic structure chart for the method according to the invention for transferring operating data of the automation system to the cloud memory.

### DETAILED DESCRIPTION OF THE DRAWINGS

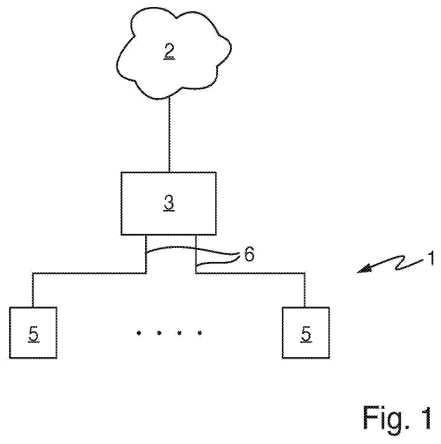

FIG. 1 shows a highly schematic view of an automation system 1, in this case in the form of an electrical drive system, and an associated gateway 3 that communicates with a cloud memory 2 of a particular type.

The automation system or electrical drive system 1 has a number of frequency converters 5 connected to the gateway 3 by way of a field bus 6 for the purpose of data interchange, wherein operating data of the frequency converters 5 are transferred to the gateway 3 by the field bus 6. The operating data are loaded into the cloud memory 2 by the gateway 3.

The type of the cloud memory 2 is selected from a set of different types of cloud memories. Merely by way of example, Microsoft Azure, Amazon AWS, SAC Cumulocity and SAP Cloud Platform may be mentioned in this regard.

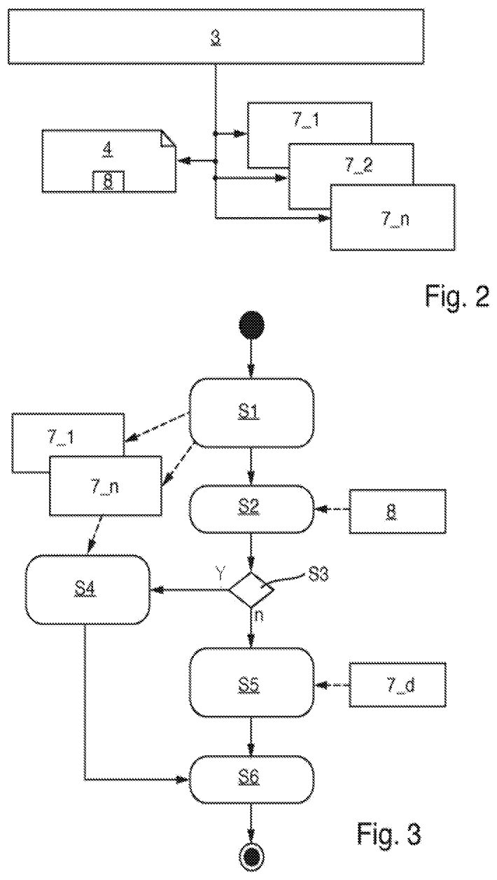

With reference to FIG. 2, a configuration file 4 has a type-determining entry 8 determining the selected type of the cloud memory 2 in which the operating data are to be loaded. On being initialized, the gateway 3 reads in the configuration file 4 and ascertains the type-determining entry 8 from the configuration file 4.

With further reference to FIG. 2, a respective type of a cloud memory 2 has an assigned type-specific formatting module 7_1 to 7_n. The gateway 3 is designed to take the previously read type-determining entry 8 of the configuration file 4 as a basis for selecting and loading the associated type-specific formatting module 7_1 to 7_n. The selected and loaded formatting module is used to format the operating data and then to load them into the cloud memory 2.

The formatting module 7_1 can be associated with the Microsoft Azure type, for example, the formatting module 7_2 can be associated with the Amazon AWS type, for example, and the formatting module 7_n can be associated with the SAC Cumulocity type, for example.

FIG. 3 shows a schematic structure chart for the method according to the invention for transferring operating data of the automation system 1 to the cloud memory 2.

First of all, the gateway 3 loads all the available formatting modules 7_1 to 7_n in a step S1.

The gateway 3 then reads the configuration file 4 and the type-determining entry 8 contained therein, which describes the type of the cloud memory 2 that is to be used or that is used, in a step S2.

In a step S3, the gateway 3 checks whether a suitable formatting module 7_1 to 7_n exists for the type-determining entry 8.

If a suitable formatting module does exist, the operating data are formatted by means of the suitable formatting module in a step S4 and published, i.e. loaded into the cloud memory 2 by means of conventional methods, in a step S6.

If a suitable formatting module does not exist, the operating data are formatted by means of a type-aspecific standard formatting module 7_d in a step S5 and then published in step S6.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A method for transferring operating data of an automation system to a cloud memory, wherein the cloud memory is selectable from a set of different types of cloud memories, the method comprising the steps of:
transferring the operating data from the automation system to a gateway;
using the gateway to read in a configuration file, wherein the configuration file has a type-determining entry determining the type of cloud memory into which the operating data are to be loaded;
using the gateway to format the operating data on the basis of the type-determining entry of the configuration file; and
using the gateway to load the formatted operating data into the cloud memory.

2. The method according to claim 1, wherein
the different types of cloud memories are selected from a set of cloud memories comprising:
Microsoft Azure,
Amazon AWS,
SAC Cumulocity,
SAP Cloud Platform.

3. The method according to claim 2, wherein
the gateway loads the formatted operating data into the cloud memory via a MQTT protocol.

4. The method according to claim 1, wherein
the gateway loads the formatted operating data into the cloud memory via a MQTT protocol.

5. The method according to claim 1, wherein
the automation system comprises a number of frequency converters connected to the gateway by a field bus for purpose of data interchange, and
the operating data of the frequency converters are transferred to the gateway by means of the field bus.

6. The method according to claim 1, wherein
a respective type of a cloud memory selected from a set of types of cloud memories is assigned a type-specific formatting module selected from a set of type-specific formatting modules, and
the gateway is configured to take the type-determining entry of the configuration file as a basis for selecting the associated type-specific formatting module from the set of type-specific formatting modules and to use the selected formatting module to format the operating data.

7. The method according to claim 6, wherein
the gateway is configured to format the operating data by a type-aspecific standard formatting module if the type-determining entry of the configuration file has no assigned type-specific formatting module in the set of type-specific formatting modules.

8. The method according to claim 1, wherein
the gateway is configured to format the operating data by a type-aspecific standard formatting module if the type-determining entry of the configuration file has no assigned type-specific formatting module in the set of type-specific formatting modules.

9. An apparatus for transferring operating data of an automation system to a cloud memory selectable from a set of different cloud memories, comprising:
a gateway configured to execute acts of:
receiving operating data from the automation system,
reading-in a configuration file, wherein the configuration file has a type-determining entry determining a type of cloud memory into which the operating data are to be loaded, formatting the operating data based on the type-determining entry of the configuration file, and
loading the formatted operating data into the cloud memory.
